(19) United States
(12) Patent Application Publication
(10) Pub. No.: US 2005/0188385 A1
(43) Pub. Date: Aug. 25, 2005

(54) Information processing device, information processing method thereof, information processing program thereof and recording medium storing the program

(75) Inventors: Yoshihiro Ichikawa, Tokorozawa-shi (JP); Yoshitake Shimada, Tokorozawa-shi (JP); Yusuke Akama, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/059,306

(22) Filed: Feb. 17, 2005

(30) Foreign Application Priority Data
Feb. 19, 2004 (JP) 2004-042671

(51) Int. Cl. G11B 17/03

(52) U.S. Cl. 720/600

(57) ABSTRACT

A disc drive (200), which has a disc tray (210) that carries an optical disc (10) and can be moved back and forth, is adapted to be moved out of and back into a case body (110) through an opening (111) by a mover unit. When the disc drive (200) is being moved, the drive operation of the spindle motor of the disc drive (200) is suspended to prevent the optical disc from rotating. The disc drive (200) is allowed to read information from and/or record information on the optical disc (10) only at the home position where it is housed in the case body (110) through the opening (111). Thus, the disc drive (200) is prevented from damaging the optical disc and other components by impact when it is being moved.

### BACKGROUND OF THE INVENTION

1. Field of the Invention

The present invention relates to an information processing device for processing information, an information processing method thereof, an information processing program thereof and a recording medium storing the a program.

2. Description of related Art

Such a configuration has been known as a device which reads signals from a disc-shaped recording medium by an optical head section and detects that the disc-shaped recording medium is properly loaded by the read signal when the disc-shaped recording medium is loaded (see, for example, Reference: Japanese Patent Laid-Open Publication No. Hei 6-342550, page 3, left column to page 9, left column). With the device described in the above-cited Reference, when a loading motor is driven to start a loading operation, an objective lens of the optical head section is placed at a position minimally separated from the disc surface that is the upper limit of the information movable range in a focus searching operation. Then, a laser beam is output to determine the presence or absence of an FOK signal to judge if a disc is loaded or not.

In such discs as the one described in the above-cited Reference are accompanied by problems including that the disc-shaped recording medium and/or the optical head section can be damaged by external vibration and/or impact during the loading operation of the disc-shaped recording medium if the optical head section and the moving disc-shaped recording medium contact each other. On the other hand, there is a strong demand for downsized low cost information processing devices to accommodate the trend of downsizing display devices for reproducing information such as image data and other devices for outputting processed information.

### SUMMARY OF THE INVENTION

An object of the present invention is to provide an information processing device that can read information from and write information to a recording medium effectively and efficiently as well as an information processing method thereof, an information processing program thereof and a recording medium storing the program.

An information processing device according to the first aspect of the present invention includes: a case body having an opening; a drive main body arranged in the case body so as to be able to move out of and back into the case body through the opening and having an information processing section for reading information recorded on a recording medium and/or recording the information on the recording medium and a drive unit for moving at least either the information processing section or the recording medium relative to the other, the recording medium being loadable and unloadable when the drive main body is moved out of the case body through the opening; a processing unit arranged in the case body and connected to the drive main body so as to be able to transmit information to and receive information from the drive main body to process the information; a mover unit arranged in the case body for moving the drive main body out of and back into the case body through the opening; and a drive main body controller for restricting the drive operation of the drive unit when the drive main body is moving.

According to the second aspect of the present invention, an information processing device adapted to move a drive main body out of and back into a case body through an opening of the case body by a mover unit, the drive main body having an information processing section for reading information recorded on a recording medium and/or recording the information on the recording medium and a drive unit for moving at least either the information processing section or the recording medium relative to the other, and the recording medium being loadable and unloadable relative to the drive main body, the device includes: a drive main body controller for restricting the drive operation of the drive unit when the drive main body is moving between a position where it is moved out of the case body through the opening so as to make the recording medium loadable and unloadable relative to the drive main body and a position where it is fully retracted into the case body through the opening.

An information processing device according to the third aspect of the present invention includes: a case body having an opening; a drive main body arranged in the case body so as to be able to move out of and back into the case body through the opening and having an information processing section for reading information recorded on a recording medium and/or recording the information on the recording medium and a drive unit for moving at least either the information processing section or the recording medium relative to the other, the recording medium being loadable and unloadable when the drive main body is moved out of the case body through the opening; a processing unit arranged in the case body and connected to the drive main body so as to be able to transmit information to and receive information from the drive main body to process the information; a mover unit arranged in the case body for moving the drive main body between a position fully retracted in the case body through the opening and a position fully moved out of the case body where the recording medium is loadable and unloadable; and a drive main body controller for allowing the information processing section to read and/or record the information only when the drive main body is at the position fully retracted in the case body through the opening.

According to the fourth aspect of the present invention, an information processing device adapted to move a drive main body out of and back into a case body through an opening of the case body by a mover unit, the drive main body having an information processing section for reading information recorded on a recording medium and/or recording the information on the recording medium and a drive unit for moving at least either the information processing section or the recording medium relative to the other, and the recording medium being loadable and unloadable relative to the drive main body, the device includes: a drive main body controller for allowing the information processing section to read and/or record the information only when the drive main body is at a position fully retracted in the case body through the opening.

According to the fifth aspect of the present invention, an information processing method adapted to move a drive main body out of and back into a case body through an opening of the case body by a mover unit, the drive main body having an information processing section for reading information recorded on a recording medium and/or recording the information on the recording medium and a drive unit for moving at least either the information processing section or the recording medium relative to the other, the recording medium being loadable and unloadable relative to the drive main body; the drive operation of the drive unit being restricted when the drive main body is moving between a position where it is moved out of the case body through the opening so as to make the recording medium to be loadable and unloadable relative to the drive main body and a position where it is fully retracted into the case body through the opening by the mover unit.

According to the sixth aspect of the present invention, an information processing device method to move a drive main body out of and back into a case body through an opening of the case body by a mover unit, the drive main body having an information processing section for reading information recorded on a recording medium and/or recording the information on the recording medium and a drive unit for moving at least either the information processing section or the recording medium relative to the other, the recording medium being loadable and unloadable relative to the drive main body; the drive main body allows the information processing section to read and/or record the information only at the position fully retracted in the case body through the opening.

According to the seventh aspect of the present invention, an information processing program for causing an operation unit to execute the above-described information processing method of the present invention.

According to the eighth aspect of the present invention, a recording medium stores the above-described information processing program of the present invention in a manner readable by a computing unit.

### BRIEF DESCRIPTION OF THE DRAWINGS

FIGS. 1A through 1C are perspective views of an information processing device according to an embodiment of the present invention, of which FIG. 1A is a perspective view showing a home position of a disc drive housed therein, FIG. 1B is a perspective view showing a state of the disc drive being outwardly projecting from the home position, and FIG. 1C is a perspective view showing a state of a tray of the disc drive being projecting from the disc drive;

FIG. 2 is an exploded perspective view showing linking condition of a mover unit and the disc drive according to the embodiment;

FIGS. 3A and 3B are illustrations showing a condition in which the disc drive is moved up and down by the mover unit according to the embodiment, of which FIG. 3A is a lateral view showing a home position of the disc drive accommodated therein, FIG. 3B is a lateral view showing a state of the disc drive being outwardly projecting from the home position;

FIG. 4 is a block diagram showing an internal configuration of the according to the embodiment; and

FIG. 5 is a flow chart showing a,processing operation of information according to the present embodiment.

### DETAILED DESCRIPTION OF PREFERRED EMBODIMENTS

Now, the present invention will be described by referring to the accompanying drawings. While the present embodiment exemplifies an information processing device including a disc drive as a drive main body for recording information on and reading information from a disc-shaped recording medium, which is an optical disc, the information processing device according to the present invention may have a drive main body adapted to record information on and read information from a disc-shaped recording medium of some other type such as a magnetic disc or a magnetic optical disc or any recording medium such as a memory card or a magnetic tape. Information that can be recorded on and read from such a recording medium may include programs, application software, game software and so on as well as video data, image data, music data, voice data.

[Structure of Information Processing Device]

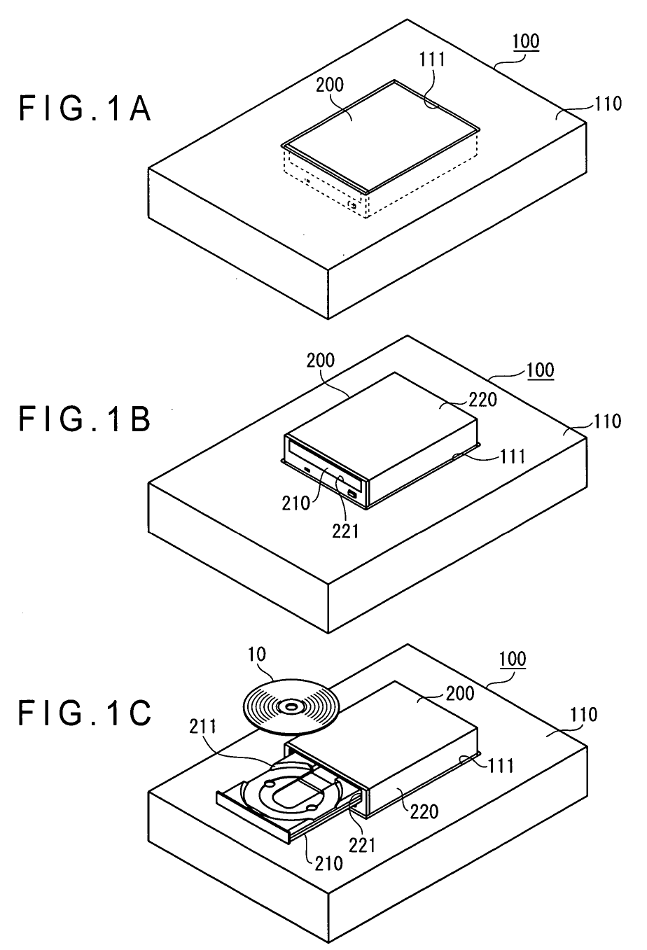

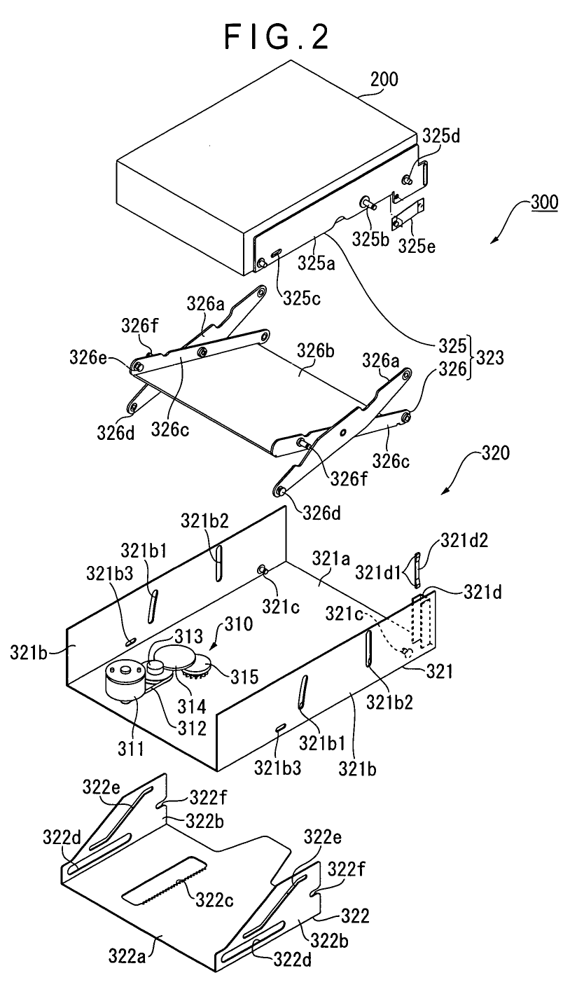

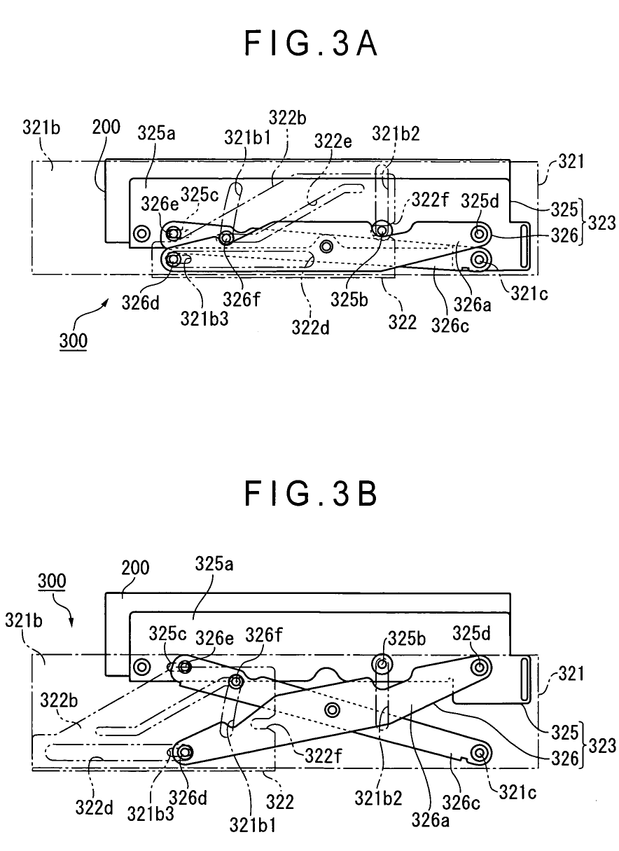

FIGS. 1A through 1C are perspective views showing the information processing device according to the present embodiment, of which FIG. 1A is a perspective view showing a home position of the disc drive housed therein, FIG. 1B is a perspective view showing a state of the disc drive being outwardly projecting from the home position, and FIG. 1C is a perspective view showing a state of a tray of the disc drive being projecting from the disc drive. FIG. 2 is an exploded perspective view showing linking condition of a mover unit and the disc drive. FIGS. 3A and 3B are illustrations showing a state in which the disc drive is moved up and down by the mover unit, of which FIG. 3A is a lateral view showing the a home position of the disc drive accommodated therein and FIG. 3B is a lateral view showing a state of the disc drive being outwardly projecting from the home position.

In FIGS. 1A through 1C, the numeral 100 denotes an information processing device. The information processing device 100 acquires information that is externally input by appropriately processing it and outputs information having been acquired by appropriately processing it. The information processing device 100 has a substantially cubic case body 110. The case body 110 is provided with an accommodation space having a substantially concave shape with an opening 111 exposed to the outside at the top surface of the case body 110. A disc drive 200 is arranged in the accommodation space of the case body 110 so as to operate as a drive main body that can move out and in through the opening 111.

The disc drive 200 records information on and reads information from an optical disc 10 as a recording medium removably loaded thereon. The disc drive 200 has a disc tray 210 on which the optical disc 10 is placed when the disc drive 200 is projecting outward from the opening 111. More specifically, the disc tray 210 is arranged to move back and forth through a loading aperture 221 located at the front side of a housing 220 of the disc drive 200. The disc tray 210 is typically made of synthetic resin and substantially flat and plate-shaped. It has a substantially cylindrical loading recess 211 formed from the top surface thereof, in which the optical disc 10 is be loaded. The disc tray 210 can move back and forth through the loading aperture 221 of the disc drive 200 along the flat surface so that it can move between a position illustrated in FIG. 1B and a position illustrated in FIG. 1C to move in and out the optical disc 10. In other words, the disc tray 210 moves in a radial direction of the optical disc 10 loaded on it.

The disc drive 200 of the information processing device 100 can move up and down in a thickness direction of the optical disc 10 loaded thereon so that it can moves up and down between a position illustrated in FIG. 1A and a position illustrated in FIG. 1B. A lid (not shown) is integrally formed on the top surface of the housing 220 of the disc drive 200, which has a profile corresponding to the profile of the opening 111 of the case body 110. The opening of the information processing device 100 is closed by the lid when the disc drive 200 is fully housed in the accommodation space of the device 100.

As shown in FIGS. 2, 3A and 3B, the case body 110 is provided in the inside thereof with a mover unit 300 for moving the disc drive 200 up and down through the opening 111. As shown in FIG. 2, the mover unit 300 has a drive section 310, a movable section 320, a detection sensor (not shown) and the like. The drive section 310 typically has an electric motor and a solenoid and drives the movable section 320 to move for operation. The movable section 320 is arranged at the bottom of the accommodation space and linked to the disc drive 200 so that it operates to move up and down the disc drive 200 as it is driven by the drive section 310. The detection sensor is arranged in the movable section 320 and detects the disc drive 200 retracted through the opening 111 and fully housed in the accommodation space and outputs a signal indicating that the disc drive 200 is at the home position.

More specifically, the drive section 310 has an electric motor 311, a pulley 313 with an endless belt 312 wound around the output shaft (not shown) of the electric motor 311, a gear 314 engaged with the pulley 313 and a transmission gear 315 engaged with the gear 314. The drive section 310 is arranged integrally with the movable section 320 so that it drives the movable section 320 to move and operate by way of the pulley 313, the gear 314 and the transmission gear 315 that are driven by the electric motor 311.

The movable section 320 has a seat section 321, a cam section 322 and a link mechanism section 323. The seat section 321 typically made of steel plate includes a bottom plate section 321a having substantially plate-shaped and a pair of lateral plate sections 321b produced by bending the bottom plate section 321a upwardly in the same direction so as to be opposite to each other. In other words, the seat section 321 has a substantially U-shaped profile in cross section. The seat section is arranged in such a way that the top edges of the lateral plate sections 321b are located close to the edges of the opening of the case body 110 to define the accommodation space. On the bottom plate section 321a, the drive section 310 is arranged in such a way that the electric motor 311 is located on one edge and the transmission gear 315 is projecting from the bottom surface, while the detection sensor is also arranged on the bottom surface. Each of the lateral plate section 321b is provided with a first long slit 321b1 and a second long slit 321b2 extending substantially along the bending direction thereof and also with a third long slit 321b3 extending horizontally in a direction perpendicular to the bending direction thereof. Each of the lateral plate sections 321b is additionally provided with a pivot pin 321c projecting inwardly toward the other lateral plate section. Still additionally, each of the lateral plate sections 321b is provided with a movement restricting section 321d that operates as movement restricting unit. Each of the movement restricting sections 321d is a groove running vertically and showing a U-shaped cross section and has a biasing cam 321d2 arranged vertically inside and provided at the longitudinal opposite ends thereof with a pair of protruding sections 321d1 so as to reduce the width of the groove toward the vertical ends thereof.

On the other hand, the cam section 322 includes a bottom section 322a that is typically made of steel plate and substantially plate-shaped and has a width substantially same as the distance between the outer surfaces of the lateral plate sections 321b of the seat section 321 and a pair of lateral sections 322b produced by bending the bottom section 322a upwardly in the same direction so as to be opposite to each other. In other words, the cam section 322 has a substantially U-shaped profile in cross section. The cam section 322 is arranged to surround the outer surfaces of the seat section 321. The bottom section 322a is provided with a rack 322c that is engaged with the transmission gear 315 projecting from the seat section 321 of the drive section 310 so that the cam section 322 can move back and forth relative to the seat section 321 in a direction perpendicular to the width direction as it is driven by the drive section 310. Each of the lateral sections 322b is provided with an oblong guide hole 322d extending in the moving direction of the cam section 322 and an operation slit 322e that is inclined relative to the bottom section 322a. The vertical positional difference of the operation slit 322e defines the distance by which the disc drive 200 moves back and forth. Additionally, each of the lateral sections 322b is provided with a positioning recess 322f that is a notch formed by cutting an edge of the moving direction.

The link mechanism section 323 has a pivot member 325 and a link member 326. The pivot member 325 includes a link plate member (not shown) that is typically made of steel plate and substantially plate-shaped and shows a profile substantially same as that of the bottom surface of the disc drive 200 and a pair of pivot plate sections 325a produced by bending the link plate section along the lateral opposite edges thereof in the same direction. In other words, the pivot member 325 has a substantially U-shaped profile in cross section. The pivot member 325 is integrally fitted to the bottom surface and the oppositely disposed lateral surfaces of the disc drive 200 typically by screws. Each of the pivot plate sections 325a is provided with a guide pin 325b projecting therefrom and adapted to be inserted into the corresponding long slit 321b2 of the seat section 321 for engagement. Additionally, each of the pivot plate sections 325a is provided with an oblong link hole 325c extending longitudinally in a direction perpendicular to the lateral direction of the disc drive 200 and adapted to be engaged with the link member 326. Still additionally, each of the pivot plate sections 325a is provided with a link pin 325d projecting therefrom and adapted to be linked to the link member 326. Furthermore, each of the pivot plate sections 325a is provided with a leaf spring 325e that constitutes the movement restricting unit along with the corresponding movement restricting section 321d. The leaf spring 325e is separated from the corresponding pivot plate section 325a at a first end thereof and fitted to the pivot plate section 325a at a second end thereof in such a way that the first end is elastically deformable in a direction so as to move closer to the pivot plate section 325a. In other words, the first end of the leaf spring 325e is so arranged as to be vertically slidable on the inner surface of the corresponding movement restricting section 321d, and as it slides vertically, it can be elastically deformed by the protruding sections 321d1 of the corresponding biasing cam 321d2, and thus preventing rattling when the disc drive 200 is moved.

On the other hand, the link member 326 of the link mechanism section 323 has a pair of longitudinally oblong and plate-shaped first arm sections 326a and a pair of longitudinally oblong and plate-shaped second arm sections 326c that are held opposite to each other and separated from each other by a plate-shaped link section 326b by a predetermined lateral distance. Each of the first arm sections 326a is pivoted substantially at the middle point thereof to the center of the corresponding second arm section 326c. The first arm section 326a is rotatively pivoted at an end thereof to the corresponding link pin 325d of the pivot member 325 and provided at the other end thereof with a first pivot pin 326d that is to be slidably held in the corresponding third long slit 321b3 of the seat section 321. The second arm section 326c is pivoted at an end thereof to the corresponding pivot pin 321c of the seat section 321 and provided at the other end thereof with a second pivot pin 326e that is to be inserted into the corresponding link hole 325c of the seat section 321 so as to be slidable. The second arm section 326c is additionally provided with a positioning pin 326f projecting therefrom and inserted in the corresponding operation slit 322e of the cam section 322 by way of the corresponding first long slit 321b1 of the seat section 321 so as to be slidable.

The cam section 322 of the movable section 320 moves back and forth relative to the seat section 321 as it is driven by the electric motor 311 of the drive section 310. As the cam section 322 is driven to move, the positioning pins 326f of the link mechanism section 323 that are inserted respectively into the corresponding operation slits 322e of the cam section 322 slide in the operation slits 322e to move vertically. Then, the first arm sections 326a and the second arm sections 326c of the link mechanism section 323 rotate relative to each other to drive the pivot member 325 fitted to the disc drive 200 to move also vertically. As a result, the disc drive 200 advances and retreats from the opening 111. During the vertical movement of the disc drive 200, the leaf springs 325e are elastically deformed to a large extent by the movement restricting sections 321d when the disc drive 200 is located near the home position as shown in FIGS. 1A and 3A and when it is moved out of the opening 111 as shown in FIGS. 1C and 3B so that consequently the disc drive 200 is prevented from rattling by the elastic force of the leaf springs 325e when it moves up and down. On the other hand, the elastic deformation of the leaf springs 325e is reduced to reduce the elastic force thereof at intermediary positions on the way of movement so that the force for preventing the disc drive 200 from rattling during the vertical movement thereof is also reduced, which reduces the load of the movement. When the disc drive 200 is located at the home position as shown in FIGS. 1A and 3A, the detection sensor detects the cam section 322 and outputs a signal telling that the disc drive 200 is at the home position.

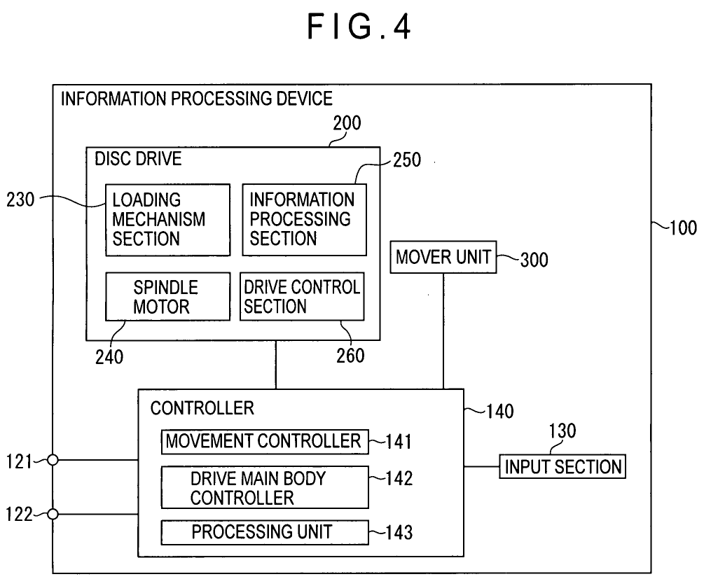

Now, the internal configuration of the information processing device 100 will be described by referring to FIG. 4. FIG. 4 is a block diagram of the information processing device 100, illustrating the internal configuration thereof.

The information processing device 100 includes an input terminal 121, an output terminal 122, the disc drive 200, the mover unit 300, an input section 130 and a controller 140 that is a computing unit, all of which are arranged in the case body 110. The input terminal 121 is exposed to the outside at an outer surface of the case body 110 through which information is input from outside. The output terminal 122 is also exposed to the outside at an outer surface of the case body 110 so as to output information to the outside.

The disc drive 200 has a loading mechanism section 230, a spindle motor 240 as a drive unit, an information processing section 250 and a drive control section 260, all of which are arranged in the housing 220. The loading mechanism section 230 moves the above-described disc tray 210 horizontally back and forth through the loading aperture 221 of the housing 220 under the control of the drive control section 260. The loading mechanism section 230 and the disc tray 210 that is driven to move by the loading mechanism section 230 constitute the transfer unit of the present invention. The spindle motor 240 drives the loaded optical disc 10 to rotate under the control of the drive control section 260. The information processing section 250 has a pickup (not shown) and records the information output from the drive control section 260 on the recording surface of the optical disc 10 under the control of the drive control section 260. The information processing section 250 also reads recorded information to output to the drive control section 260 under the control of the drive control section 260. The drive control section 260 controls the loading mechanism section 230, the spindle motor 240 and the information processing section 250 according to the signal from the controller 140 and operates to record the information output from the controller 140 on the optical disc 10 and read recorded information so as to output it to the controller 140.

As described above, the mover unit 300 includes the drive section 310, a movable section 320, a detection sensor and the like. The drive section 310 drives the movable section 320 to move the disc drive 200 up and down through the opening 111 between the position illustrated in FIG. 1A and the position illustrated in FIG. 1B according to a signal from the controller 140. The detection sensor includes a switch that is turned on or off depending on the moving condition of the movable section 320. It detects the disc drive 200 located at the home position as shown in FIG. 1A after the disc drive 200 is moved down through the opening 111 and housed in the accommodation space and the opening 111 is closed by the lid. Then, it outputs a signal to the controller 140 telling that the disc drive 200 is at the home position.

The input section 130 has an operation section that include a plurality of operation buttons and operation knobs (not shown) exposed to the outside at an outer surface of the case body 110. The input section 130 outputs a predetermined signal in response to an input operation executed at the operation section to the controller 140, which makes the controller 140 set according to the input operation. Alternatively, the input section 130 may be so arranged that it outputs a predetermined signal in response to an input operation executed through, for example, a wireless medium such as a remote control unit.

The controller 140 typically has a circuit mounted on a circuit board (not shown) and appropriately receives the signal from the input section 130 and controls the entire information processing device 100 for various processing operations. More specifically, it acquires and processes various signals and information, appropriately outputs a signal to the disc drive 200 so as to control the drive control section 260 and move the disc drive 200 and also appropriately outputs signals to the drive section 310 of the mover unit 300 so as to drive the drive section 310 in order to move the disc drive 200 up and down through the opening 111. The controller 140 also has a movement controller 141, a drive main body controller 142 and a processing unit 143 that are realized by programs to be executed on an OS (operating system) for controlling the entire information processing device 100 for operation.

The movement controller 141 appropriately supplies an electric current to the drive section 310 of the mover unit 300 so as to move the disc drive 200 up and down. The movement controller 141 reads the value of the electric current that flows to the drive section 310 so as to detect the drive condition of the drive section 310. The movement controller 141 recognizes the signal from the detection sensor of the mover unit 300 and determines if the disc drive 200 is at the home position as shown in FIG. 1A or not.

The drive main body controller 142 outputs a predetermined signal to the drive control section 260 so as to have the drive control section 260 control the movement of the disc drive 200. More specifically, it controls the operation of the loading mechanism section 230 for driving the disc tray 210 of the disc drive 200 to move back and forth, the operation of the spindle motor 240 for rotating the optical disc 10 loaded on the disc drive 200 and the operation of the information processing section 250 having a pickup for recording information on and reading recorded information from the recording surface of the optical disc 10 loaded on the disc drive 200 for controlling recording and reading processes of information. Additionally, when the drive main body controller 142 recognizes that the drive section 310 of the mover unit 300 is in operation under the control of the movement controller 141 and the disc drive 200 is moving, it controls so as not to operate the spindle motor 240 (i.e. not to rotate the optical disc 10). Still additionally, when the drive main body controller 142 recognizes that the disc drive 200 is retracted from the opening 111 of the case body 110 and not located at the home position in FIG. 1A, under the control of the movement controller 141, it restricts the operation of the information processing section 250 of the disc drive 200 so as not to allow it to record and read any information.

The processing unit 143 acquires and appropriately processes information input to the input terminal 121 and outputs it to the disc drive 200. It also acquires and appropriately processes information output from the disc drive 200 and outputs it by way of the output terminal 122. More specifically, the processing unit 143 acquires video data, image data, voice data and/or music data as information input to the input terminal 121, appropriately processes the acquired data for decoding or encoding and outputs the data to the disc drive 200. It then controls the operation of the disc drive 200 by the drive main body controller 142 to appropriately record data on the optical disc 10. Additionally, the processing unit 143 controls the operation of the disc drive 200 by the drive main body controller 142 to read video data, image data, voice data and/or music data recorded on the disc drive 200 and acquires the read data and appropriately processes the data for decoding or encoding to output the data from the output terminal 122.

[Operation of Information Processing Device]

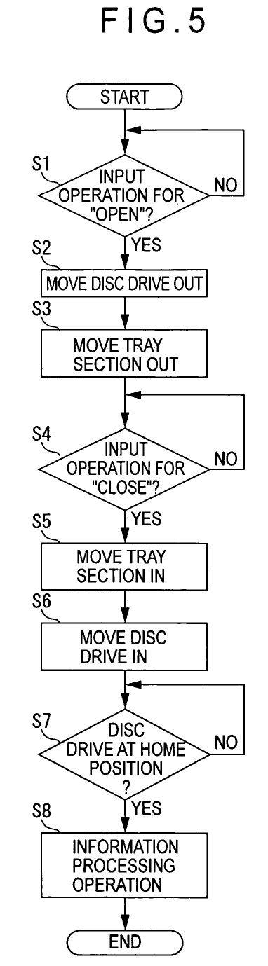

Now, the information processing operation of the above-described information processing device will be described by referring to FIG. 5. FIG. 5 is a flow chart showing the information processing operation.

Firstly, power is supplied to the information processing device 100. Then, as the user inputs an “open” command for driving the disc tray 210 to move upward by the input section 130 of the information processing device 100, the controller 140 recognizes the command by way of the signal output from the input section 130 (Step S1). As a result, the controller 140 outputs a predetermined signal to the drive section 310 of the mover unit 300 by the movement controller 141 to operate the drive section 310 for driving the movable section 320 to move and make the disc drive 200 move up through the opening 111 (Step S2). Then, as the movement controller 141 of the controller 140 recognizes that the disc drive 200 moves up through the opening 111 to the uppermost position as shown in FIG. 1B and a predetermined load is applied to the movable section 320 being in a condition unmovable any further and that the electric current for driving the drive section 310 rises above a predetermined level, it determines that the disc drive 200 has fully moved up and controls the drive section 310 to stop its operation by stopping the power supply to the drive section 310. Thereafter, the drive main body controller 142 of the controller 140 outputs a predetermined signal to the drive control section 260 of the disc drive 200 to drive the loading mechanism section 230 to operate by the drive control section 260 so as to force the disc tray 210 to move out (Step S3).

In the state that the disc tray 210 is moved up and located at the position shown in FIG. 1C, when a user loads the optical disc 10 on the disc tray 210 and inputs a “close” command for driving the disc tray 210 to retract by the input section 130, the controller 140 recognizes the signal output from the input section 130 in response to the “close” command (Step S4). As a result, the drive main body controller 142 of the controller 140 outputs a predetermined signal to the drive control section 260 of the disc drive 200 in order to drive the loading mechanism section 230 of the drive control section 260 to retract the disc tray 210 (Step S5). Thereafter, as the controller 140 recognizes the signal from the drive control section 260 telling that the disc tray 210 is retracted and the operation of the loading mechanism section 230 for moving the optical disc 10 into the disc drive is completed, it outputs a predetermined signal to the drive section 310 of the mover unit 300 to make the movable section 320 operate so as to retract the disc drive 200 into the accommodation space through the opening 111 (Step S6). Then, as a signal telling that the disc drive 200 is moved back to the home position in the accommodation space is output from the detection sensor of the mover unit 300, the controller 140 drives the drive section 310 to stop the operation.

As the controller 140 recognizes the signal from the detection sensor of the mover unit 300 (Step S7), the drive main body controller 142 outputs a predetermined signal to the drive control section 260 to carry out a preprocessing operation necessary for recording information on or acquiring recorded information from the optical disc 10 by the disc drive 200. More specifically, it rotates the spindle motor 240 and moves the pickup along the recording surface of the optical disc 10 for the purpose of focus control, tracking control, determination if the optical disc 10 is in place or not and determination of the type of the optical disc 10. Thereafter, an operation of recording information or reading information will be conducted depending on the input operation at the input section 130 (Step S8).

[Advantages of Information Processing Device]

As described above in detail, in the present embodiment, when the disc drive 200 disposed in the case body 110 so as to be movable in up and down direction through the opening 111 by the mover unit 300 is being moved by the mover unit 300, the operation of the spindle motor 240 of the disc drive 200 is restricted by the drive main body controller 142 of the controller 140 and hence the optical disc 10 is held not to revolve. Therefore, when the information processing device 100 is integrally combined with some output device such as a monitor or a speaker for outputting information from the design point of view, and the disc drive 200 is adapted to be moved out of and back into the case body 110 for of easiness of loading/unloading the optical disc 10, the present invention provides an advantage of preventing the optical disc 10 from damaging the optical disc 10 itself and other components like the pickup held in contact with the optical disc 10 when the optical disc 10 is rotated by the spindle motor 240 and accidentally hits the disc tray 210 and/or the pickup due to the vibration of the disc drive 200 while the disc drive 200 is driven to move by the mover unit 300. Therefore, information can be securely recorded and read out. Additionally, since the disc drive 200 is adapted to be moved in the above description, an existent disc drive 200 can be used. In other words, no special configuration is required to record and read information, and therefore the information processing device 100 can be manufactured with improved productivity and supplied at low cost.

Additionally, if the disc drive 200 is not being moved, the spindle motor 240 may be driven to operate. Therefore, the spindle motor 240 can be temporarily driven to securely hold the optical disc 10 when the disc tray 210 is moved into the disc drive 200. In other words, the optical disc 10 can be securely held by temporarily driving the spindle motor 240 before moving the disc drive 200 by the mover unit 300. Thus, information can be securely recorded and read out.

Information can be read and/or recorded only in a state where the disc drive 200 is housed in the case body 110. In other words, information can be neither read nor recorded until the operation of moving the disc drive 200 into the case body 110 is completed. Thus, the present invention provides an advantage of preventing the optical disc 10 from damaging the optical disc 10 itself and other components like the pickup held in contact with the optical disc 10 when the optical disc 10 is rotated and accidentally hits the disc tray 210 and/or the pickup due to the vibration of the disc drive 200 while the disc drive 200 is driven to move. Thus, information can be securely recorded and read out. In addition, it is possible to securely prevent damages because a preprocessing operation is not conducted until the moving operation is completed.

The drive main body controller 142 of the controller 140 can stop the operation of driving the spindle motor 240 only when the mover unit 300 is driven to operate by the controller 140, which facilitates the processing. Thus, a configuration of, for example, a processing program can be simplified so that the information processing device 100 can be manufactured with improved productivity and supplied at low cost. Additionally, since the controller 140 is constituted with a program, the information processing device 100 adapted to move the disc drive 200 in a manner as described above can be realized with a simple configuration by altering a part of the program of an existing information processing device that is designed to use the optical disc 10. Again, the productivity can be easily improved. Note that the controller 140 according to the present invention as an operation unit is not limited to a single computer but may also be a configuration including a plurality of computers that are combined by a network, a device such as a CPU or a microcomputer or a circuit board on which a plurality of electronic components are mounted.

Additionally, in order to prevent damages on the optical disc 10 and other components during the movement of the disc drive 200, a configuration in which the operation of driving the spindle motor 240 for rotating the optical disc 10 is controlled, is employed. Therefore, the configuration for controlling the operation of driving the spindle motor 240 for the purpose of preprocessing and recording/reading information can be utilized, thus simplifying the configuration.

The disc drive 200 is driven to move in a direction perpendicular to the width direction of the optical disc 10 for loading and unloading the optical disc 10. With this arrangement, the optical disc 10 can be loaded and unloaded with ease and the distance of movement of the disc drive 200 from the case body 110 is minimized. Thus, the degree of freedom for installation of the information processing device 100 is improved so that the usability is improved. Additionally, the disc drive 200 is so disposed that it can be moved out of and back into the case body 110 without particularly projecting from the periphery of the case body 110 even when the disc tray 210 is move out of the case body. Thus, the degree of freedom for installation of the information processing device 100 is further improved so that the usability is improved. Additionally, the user can smartly load and unload the optical disc 10 to broaden utilization of information processing devices according to the present invention.

For a configuration to move the disc drive 200, the link mechanism having the cam section 322 and the link mechanism section 323 to convert the back and forth movement of the cam section 322 into the up and down is utilized, so that the detection sensor that can detect the home position through the position of the moving cam section 322 is employed. Thus, the movement and the position of the disc drive 200 can be easily recognized with a simple arrangement.

When moving the disc drive 200, a relatively large elastic force is applied to the disc drive 200 near the home position shown in FIGS. 1A and 3A and near a position where the disc drive 200 is moved out of the opening 111 as shown in FIGS. 1B, 1C and 3B in order to prevent the disc drive 200 from rattling. Thus, damages cased by the external vibration during the movement of the disc drive 200 can be prevented. Further, on a middle part of the movement the disc drive 200 is prohibited from moving by itself and hence the elastic force is reduced to reduce the load necessary for moving the disc drive 200. Thus, the disc drive 200 is moved smoothly.

[Modifications of Embodiment]

The present invention is not limited to the above specific embodiment, but includes modifications and improvements as long as the objects of the present invention can be attained.

An information processing device 100 according to the present invention is not necessarily adapted to be used for the optical disc 10. It may alternatively be used for any disc-shaped recording medium of some other types such as a magnetic disc or a magnetic optical disc from which information can be reproduced and on which information can be recorded by way of light or magnetism, or a recording medium such as a memory card or a magnetic tape for storing information in readable and recordable manners.

As for the drive main body, a disc drive having a loading mechanism section that does not use a disc tray 210 or a disc drive adapted to operate an optical disc 10 such as MD (mini disc), which is housed in a case so as to be able to rotate freely, may alternatively be used. In short, any arrangement for recording information and reading information by way of a relative movement of a recording medium and the information processing section 250 produced by a drive unit can be used for the purpose of the present invention. An information processing device according to the present invention is not necessarily adapted to record and read information. It may alternatively be adapted only to read information or only to record information. While a spindle motor 240 is used as drive unit for rotating the optical disc 10 in the above description, the present invention is not limited thereto and any other drive unit may alternatively be used. Furthermore, while the recording medium is rotated or moved, in the above description, the present invention is not limited thereto and alternatively the information processing section 250 for recording and reading information may be relatively moved or both the recording medium and the information processing section 250 may be moved relative to each other.

Any mover unit 300 can be used for the purpose of the present invention so long as it drives the drive main body to move out of and back into the case body 110 through the opening 111. It does not necessarily have to drive the disc drive 200 to move up and down. Alternatively, it may drive the disc drive 200 in the moving direction of the disc tray 210. Still alternatively, it may drive the disc drive 200 in a plurality of different directions.

While the processing unit 143 for processing information, the drive main body controller 142 for controlling the movement of the disc drive 200 and the movement controller 141 for controlling the movement of the mover unit 300 are realized by programs configured as the controller 140 in the above description, the present invention is not limited thereto and they may alternatively be realized by hardware such as a circuit board or a single element such as an IC (integrated circuit). They can be handled with ease to consequently broaden the utilization of information processing devices according to the present invention when they are realized by programs that can be read out from some other recording medium.

While the spindle motor 240 can be operated only after housing the disc tray 210 in the disc drive 200 and moving the disc drive 200 back to the home position in the above description, the present invention is not limited thereto. Alternatively, the spindle motor 240 may be driven to operate once after housing the disc tray 210 in the disc drive 200 to securely hold the optical disc 10 before moving the disc drive 200 back to the home position to execute recording processing or reading process of information. What is necessary is that the spindle motor 240 is not driven while the disc drive 200 is moving and information is recorded or read only when the disc drive 200 is at the home position.

Any arrangement may be used for the mover unit 300 for moving the disc drive 200 so long as it can move the disc drive 200 out of and back into the case body 110.

The arrangements and the operating procedures for the present invention may be appropriately modified as long as the scope of the present invention can be attained.

[Advantages of Embodiments]

As described above, with the above embodiment, the operation of driving the spindle motor 240 of the disc drive 200 is restricted and hence the optical disc 10 is held so as not to be rotate by the drive main body controller 142 of the controller 140 when the disc drive 200 which can be moved out of and back into the case body 110 through the opening 111 by the mover unit 300, is actually being moved by the mover unit 300. With this arrangement, the optical disc 10 is prevented from damaging the optical disc 10 itself and other components like the pickup that is held in contact with the optical when the optical disc 10 is rotated by the spindle motor 240 and accidentally hits the disc tray 210 and/or the pickup while the disc drive 200 is moved by the mover unit 300. Therefore, information can be securely recorded and read out.

Additionally, with the above-described embodiment, the information processing section 250 can read information and/or record information only when the disc drive 200, which can be moved out of and back into the case body 110 through the opening 111 by the mover unit 300, is retracted to the home position through the opening 111. With this arrangement, the disc drive 200 is prevented from being subjected to external impact when it is moved out of the case body 110, while the optical disc 10 is prevented from damaging the optical disc 10 itself and other components like pickup that is held in contact with the optical disc 10 by the impact that may arise when the optical disc 10 is rotated by the spindle motor 240 and accidentally hits the disc tray 210 and/or the pickup due to the impact caused when it is moved out of or back into the case body 110 through the opening 111. Therefore, information can be securely recorded and read out.

The priority application Number JP2004-042671 upon which this patent application is based is hereby incorporated by reference.

1. An information processing device comprising:
a case body having an opening;
a drive main body arranged in the case body so as to be able to move out of and back into the case body through the opening and having an information processing section for reading information recorded on a recording medium and/or recording the information on the recording medium and a drive unit for moving at least either the information processing section or the recording medium relative to the other, the recording medium being loadable and unloadable when the drive main body is moved out of the case body through the opening;
a processing unit arranged in the case body and connected to the drive main body so as to be able to transmit information to and receive information from the drive main body to process the information;
a mover unit arranged in the case body for moving the drive main body out of and back into the case body through the opening; and
a drive main body controller for restricting the drive operation of the drive unit when the drive main body is moving.

2. An information processing device adapted to move a drive main body out of and back into a case body through an opening of the case body by a mover unit, the drive main body having an information processing section for reading information recorded on a recording medium and/or recording the information on the recording medium and a drive unit for moving at least either the information processing section or the recording medium relative to the other, and the recording medium being loadable and unloadable relative to the drive main body, the device comprising:
a drive main body controller for restricting the drive operation of the drive unit when the drive main body is moving between a position where it is moved out of the case body through the opening so as to make the recording medium loadable and unloadable relative to the drive main body and a position where it is fully retracted into the case body through the opening.

3. The information processing device according to claim 1, wherein
the drive main body controller allows the information processing section to read and/or record the information only when the drive main body is fully retracted into the case body through the opening.

4. The information processing device according to claim 2, wherein
the drive main body controller allows the information processing section to read and/or record the information only when the drive main body is fully retracted into the case body through the opening.

5. An information processing device comprising:
a case body having an opening;
a drive main body arranged in the case body so as to be able to move out of and back into the case body through the opening and having an information processing section for reading information recorded on a recording medium and/or recording the information on the recording medium and a drive unit for moving at least either the information processing section or the recording medium relative to the other, the recording medium being loadable and unloadable when the drive main body is moved out of the case body through the opening;
a processing unit arranged in the case body and connected to the drive main body so as to be able to transmit information to and receive information from the drive main body to process the information;
a mover unit arranged in the case body for moving the drive main body between a position fully retracted in the case body through the opening and a position fully moved out of the case body where the recording medium is loadable and unloadable; and
a drive main body controller for allowing the information processing section to read and/or record the information only when the drive main body is at the position fully retracted in the case body through the opening.

6. An information processing device adapted to move a drive main body out of and back into a case body through an opening of the case body by a mover unit, the drive main body having an information processing section for reading information recorded on a recording medium and/or recording the information on the recording medium and a drive unit for moving at least either the information processing section or the recording medium relative to the other, and the recording medium being loadable and unloadable relative to the drive main body, the device comprising:
a drive main body controller for allowing the information processing section to read and/or record the information only when the drive main body is at a position fully retracted in the case body through the opening.

7. The information processing device according to claim 5, wherein
the drive main body controller restricts the drive operation of the drive unit while the drive main body is being moved by the mover unit.

8. The information processing device according to claim 6, wherein
the drive main body controller restricts the drive operation of the drive unit while the drive main body is being moved by the mover unit.

9. The information processing device according to claim 1, wherein
the recording medium is a disc-shaped recording medium; and
the drive unit of the drive main body is provided with a spindle motor for rotating the disc-shaped recording medium,
the drive main body controller being adapted to restrict the rotations of the disc-shaped recording medium by the spindle motor while the drive main body is being moved by the mover unit.

10. The information processing device according to claim 2, wherein
the recording medium is a disc-shaped recording medium; and
the drive unit of the drive main body is provided with a spindle motor for rotating the disc-shaped recording medium,
the drive main body controller being adapted to restrict the rotations of the disc-shaped recording medium by the spindle motor while the drive main body is being moved by the mover unit.

11. The information processing device according to claim 5, wherein
the recording medium is a disc-shaped recording medium; and
the drive unit of the drive main body is provided with a spindle motor for rotating the disc-shaped recording medium,
the drive main body controller being adapted to restrict the rotations of the disc-shaped recording medium by the spindle motor while the drive main body is being moved by the mover unit.

12. The information processing device according to claim 6, wherein
the recording medium is a disc-shaped recording medium; and
the drive unit of the drive main body is provided with a spindle motor for rotating the disc-shaped recording medium,
the drive main body controller being adapted to restrict the rotations of the disc-shaped recording medium by the spindle motor while the drive main body is being moved by the mover unit.

13. The information processing device according to claim 1, wherein
the drive main body is adapted to make the disc-shaped recording medium to be loadable and unloadable in a radial direction thereof; and
the mover unit is adapted to move the drive main body in a thickness direction of the disc-shaped recording medium.

14. The information processing device according to claim 2, wherein
the drive main body is adapted to make the disc-shaped recording medium to be loadable and unloadable in a radial direction thereof; and
the mover unit is adapted to move the drive main body in a thickness direction of the disc-shaped recording medium.

15. The information processing device according to claim 5, wherein
the drive main body is adapted to make the disc-shaped recording medium to be loadable and unloadable in a radial direction thereof; and
the mover unit is adapted to move the drive main body in a thickness direction of the disc-shaped recording medium.

16. The information processing device according to claim 6, wherein p1 the drive main body is adapted to make the disc-shaped recording medium to be loadable and unloadable in a radial direction thereof; and
the mover unit is adapted to move the drive main body in a thickness direction of the disc-shaped recording medium.

17. The information processing device according to claim 1, wherein
the drive main body is provided with a transfer unit for transferring the recording medium to the position for allowing the information processing section to read and/or record the information by way of a relative movement produced by the drive unit while the drive main body is at the position fully moved out of the case body through the opening.

18. The information processing device according to claim 2, wherein
the drive main body is provided with a transfer unit for transferring the recording medium to the position for allowing the information processing section to read and/or record the information by way of a relative movement produced by the drive unit while the drive main body is at the position fully moved out of the case body through the opening.

19. The information processing device according to claim 5, wherein
the drive main body is provided with a transfer unit for transferring the recording medium to the position for allowing the information processing section to read and/or record the information by way of a relative movement produced by the drive unit while the drive main body is at the position fully moved out of the case body through the opening.

20. The information processing device according to claim 6, wherein
the drive main body is provided with a transfer unit for transferring the recording medium to the position for allowing the information processing section to read and/or record the information by way of a relative movement produced by the drive unit while the drive main body is at the position fully moved out of the case body through the opening.

21. An information processing method adapted to move a drive main body out of and back into a case body through an opening of the case body by a mover unit, the drive main body including: an information processing section for reading information recorded on a recording medium and/or recording the information on the recording medium; and a drive unit for moving at least either the information processing section or the recording medium relative to the other, the recording medium being loadable and unloadable relative to the drive main body, wherein
the drive operation of the drive unit is restricted when the drive main body is moving between a position where it is moved out of the case body through the opening so as to make the recording medium to be loadable and unloadable relative to the drive main body and a position where it is fully retracted into the case body through the opening by the mover unit.

22. An information processing device method adapted to move a drive main body out of and back into a case body through an opening of the case body by a mover unit, the drive main body including: an information processing section for reading information recorded on a recording medium and/or recording the information on the recording medium; and a drive unit for moving at least either the information processing section or the recording medium relative to the other, the recording medium being loadable and unloadable relative to the drive main body, wherein
the drive main body allows the information processing section to read and/or record the information only at the position fully retracted in the case body through the opening.

23. An information processing program for causing an operation unit to execute an information processing method,
wherein the method is adapted to move a drive main body out of and back into a case body through an opening of the case body by a mover unit, the drive main body including: an information processing section for reading information recorded on a recording medium and/or recording the information on the recording medium; and a drive unit for moving at least either the information processing section or the recording medium relative to the other, the recording medium being loadable and unloadable relative to the drive main body,
wherein the drive operation of the drive unit is restricted when the drive main body is moving between a position where it is moved out of the case body through the opening so as to make the recording medium to be loadable and unloadable relative to the drive main body and a position where it is fully retracted into the case body through the opening by the mover unit.

24. An information processing program for causing an operation unit to execute an information processing method,
wherein the method is adapted to move a drive main body out of and back into a case body through an opening of the case body by a mover unit, the drive main body including: an information processing section for reading information recorded on a recording medium and/or recording the information on the recording medium; and a drive unit for moving at least either the information processing section or the recording medium relative to the other, the recording medium being loadable and unloadable relative to the drive main body,
wherein the drive main body allows the information processing section to read and/or record the information only at the position fully retracted in the case body through the opening.

25. A recording medium storing an information processing program in a manner readable by a computing unit, the program causing an operation unit to execute an information processing method,
wherein the method is adapted to move a drive main body out of and back into a case body through an opening of the case body by a mover unit, the drive main body including: an information processing section for reading information recorded on a recording medium and/or recording the information on the recording medium; and a drive unit for moving at least either the information processing section or the recording medium relative to the other, the recording medium being loadable and unloadable relative to the drive main body,
wherein the drive operation of the drive unit is restricted when the drive main body is moving between a position where it is moved out of the case body through the opening so as to make the recording medium to be loadable and unloadable relative to the drive main body and a position where it is fully retracted into the case body through the opening by the mover unit.

26. A recording medium storing an information processing program in a manner readable by a computing unit, the program causing an operation unit to execute an information processing method,
wherein the method is adapted to move a drive main body out of and back into a case body through an opening of the case body by a mover unit, the drive main body including: an information processing section for reading information recorded on a recording medium and/or recording the information on the recording medium; and a drive unit for moving at least either the information processing section or the recording medium relative to the other, the recording medium being loadable and unloadable relative to the drive main body,
wherein the drive main body allows the information processing section to read and/or record the information only at the position fully retracted in the case body through the opening.
